(19) United States
(12) Patent Application Publication
(10) Pub. No.: US 2026/0211218 A1
(43) Pub. Date: Jul. 23, 2026

(54) WIDE ANGLE OPTICAL LENS

(71) Applicant: Google LLC, Mountain View, CA (US)

(72) Inventors: Chen-cheng Lee, New Taipei City 220 (TW); Shan-Fu Huang, New Taipei City (TW)

(21) Appl. No.: 19/138,383

(22) PCT Filed: Dec. 16, 2022
(86) PCT No.: PCT/US2022/081760

§ 371 Date: Jun. 12, 2025

(51) Int. Cl. G02B 13/06; G02B 1/04; G02B 9/62; G02B 13/00

(52) U.S. Cl. CPC G02B 13/06; G02B 1/041; G02B 9/62; G02B 13/0045; G02B 13/0055

(57) ABSTRACT

A lens includes a plurality of optical elements arranged along an optical axis. The plurality of optical elements includes, in order from an object side to an image side of the lens: a first refractive lens element, an aperture stop, a second refractive lens element, a third refractive lens element, a fourth refractive lens element, and a fifth refractive lens element. A diameter of the first refractive lens element is less than 50% of a total track length of the of lens.

### BACKGROUND

Existing optical systems of cameras in electronic products are trending towards lens designs having a thinner total track length (TTL). However, to provide better image quality with higher resolution, the number of lens elements may be increased, which may increase the TTL of the optical lens system.

### SUMMARY

In general, aspects of this disclosure are directed to techniques, systems, and lenses having a wide-angle, ultra-short TTL with high quality imaging for high resolution camera systems. Example lens designs in include a plurality of plastic lens elements, with at least one of the plastic elements having a relatively high refractive index, e.g., N_{d}>1.68, where N_{d} is the refractive index at a yellow spectral line of helium having a wavelength of about 587.56 nanometer (nm).

The techniques, systems, and lenses of this disclosure may provide one or more technical advantages and solve one or more technical problems. For example, the techniques, systems, and lenses provide lens designs having an ultra-wide field of view, e.g., a diagonal field of view (DFOV) greater than or equal to 120 degrees, a ratio of TTL to maximum image height of less than or equal to 1.627 (where image height is a distance from the optical axis in the image plane at which the relative illumination is 25%), and a first lens element diameter of less than or equal to 38% of the TTL. Such lens designs provide lenses having a relatively short TTL with a small aperture and an improved, ultra-wide field of view.

In some aspects, the techniques described herein relate to a lens including: a plurality of optical elements arranged along an optical axis, wherein the plurality of optical elements comprises, in order from an object side to an image side of the lens: a first refractive lens element; an aperture stop; a second refractive lens element; a third refractive lens element; a fourth refractive lens element; and a fifth refractive lens element, and wherein the first refractive lens element, the second refractive lens element, the third refractive lens element, the fourth refractive lens element, and the fifth refractive lens element each comprise a plastic, and wherein a diameter of the first refractive lens element is less than 50% of a total track length of the of lens.

In some aspects, the techniques described herein relate to a camera including: a lens including: a plurality of optical elements arranged along an optical axis, wherein the plurality of optical elements comprises, in order from an object side to an image side of the lens: a first refractive lens element; an aperture stop; a second refractive lens element; a third refractive lens element; a fourth refractive lens element; and a fifth refractive lens element, and wherein the first refractive lens element, the second refractive lens element, the third refractive lens element, the fourth refractive lens element, and the fifth refractive lens element each comprise a plastic, and wherein a diameter of the first refractive lens element is less than 50% of a total track length of the of lens; and a sensor disposed at an image plane of the lens.

In some aspects, the techniques described herein relates to a device including: a processor; a camera; and a memory comprising instructions executable by the processor to control operations of the cameras, wherein the camera comprises: a lens comprising: a plurality of optical elements arranged along an optical axis, wherein the plurality of optical elements comprises, in order from an object side to an image side of the lens: a first refractive lens element; an aperture stop; a second refractive lens element; a third refractive lens element; a fourth refractive lens element; and a fifth refractive lens element, and wherein the first refractive lens element, the second refractive lens element, the third refractive lens element, the fourth refractive lens element, and the fifth refractive lens element each comprise a plastic, and wherein a diameter of the first refractive lens element is less than 50% of a total track length of the of lens; a sensor disposed at an image plane of the lens; and an infrared cut filter disposed between the sensor and the fifth refractive lens element.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a cross-sectional diagram of an example lens system, in accordance with one or more aspects of the present disclosure.

FIG. 2 is a plot of a modulation transfer function of the example lens system of FIG. 1, in accordance with one or more aspects of the present disclosure.

FIG. 3 is a plot of a relative illumination of the example lens system of FIG. 1, in accordance with one or more aspects of the present disclosure.

FIG. 4 is a plot of a distortion of the example lens system of FIG. 1, in accordance with one or more aspects of the present disclosure.

FIG. 5 is a cross-sectional diagram of another example lens system, in accordance with one or more aspects of the present disclosure.

FIG. 6 is a plot of a modulation transfer function of the example lens system of FIG. 5, in accordance with one or more aspects of the present disclosure.

FIG. 7 is a plot of a relative illumination of the example lens system of FIG. 5, in accordance with one or more aspects of the present disclosure.

FIG. 8 is a plot of a distortion of the example lens system of FIG. 5, in accordance with one or more aspects of the present disclosure.

FIG. 9 is an example computer system that may be used with a camera including the example lens of FIG. 1 or 5, in accordance with one or more aspects of the present disclosure.

### DETAILED DESCRIPTION

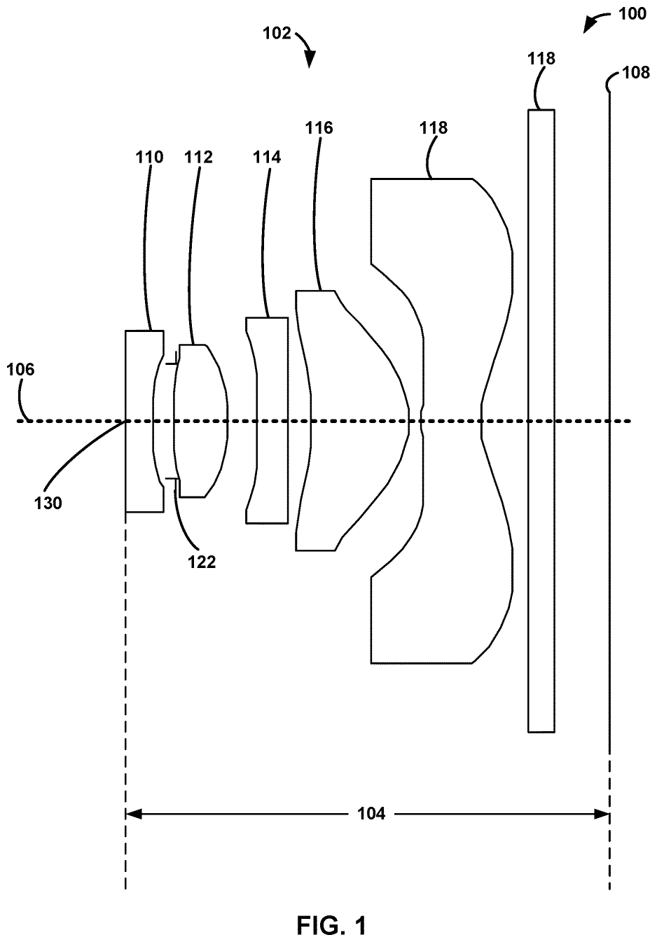

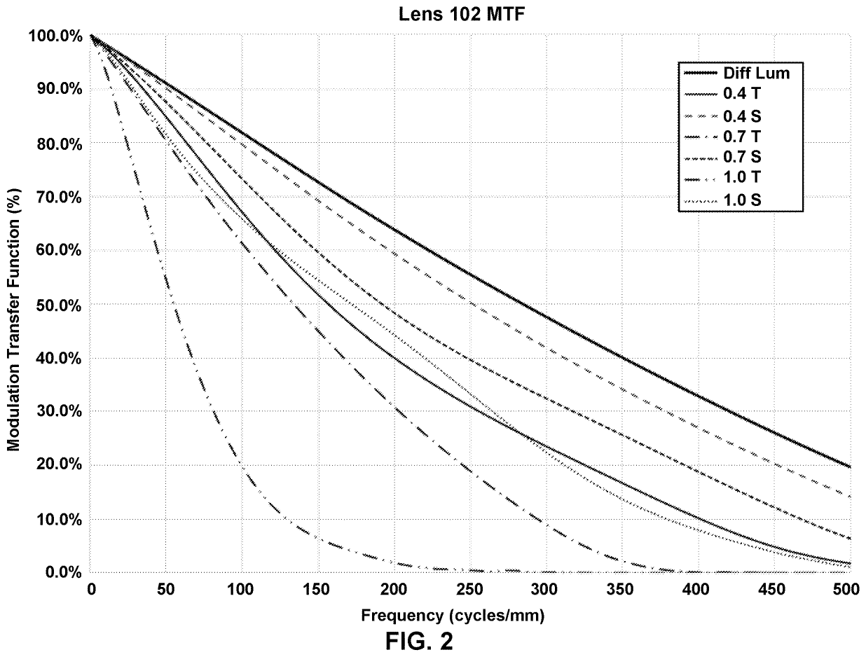

FIG. 1 is a cross-sectional diagram of an example lens system 100, in accordance with one or more aspects of the present disclosure. FIGS. 2-4 are plots illustrating lens performance and/or quality of lens system 100. Lens system 100 may include lens 102 and sensor 108, and lens 102 may include a plurality of optical elements, e.g., two or more lens elements.

In the example shown, lens 102 may include five lens elements 110, 112, 114, 116, and 118 arranged in order along an optical axis 106 from an object side to an image side, e.g., with lens element 110 as the object side lens element and lens element 118 as the image side lens element. Lens element 110 may be referred to as a first refractive lens element, lens element 112 may be referred to as a second refractive lens element, lens element 114 may be referred to as a third refractive lens element, lens element 116 may be referred to as a fourth refractive lens element, and lens element 118 may be referred to as a fifth refractive lens element, Lens 102 also may include lens stop 122 arranged on an object side of lens element 112, e.g., between lens elements 110 and 112. In other examples, lens stop 122 may be located anywhere within lens 102, e.g., anywhere within TTL 104. In some examples, lens stop 122 may be a mechanical aperture comprising an opaque material and configured to have a clear aperture, and in other examples lens stop 122 may be one of lens elements 110-118. In some examples, lens 102 may include filter 120. Filter 120 may be an optical filter, spatial filter, polarizing filter, or the like. For example, filter 120 may be an infrared (IR) cut filter configured to reduce transmission of, or be opaque to, IR wavelengths of light. Filter 120 may be formed of a plastic material, a glass material, or any suitable material. In the example shown, filter 120 does not have optical power (e.g., or refractive power, or focusing power). Although illustrated as separate components, in some examples, filter 120 may comprise a coating on a surface of one or more of lens elements 110-118 and/or a surface of sensor 108, or other methods or components may be used to provide optical filtering.

Parameters of lens 102, e.g., the overall lens 102 optical power, the optical powers of lens elements 110-118, the lens shapes, thicknesses, geometries, positions, materials, spacings, and the surface shapes of lens elements 110-118 may be selected, at least in part, to provide an ultra-wide field of view, e.g., a diagonal field of view (DFOV) greater than 90 degrees, or greater than 105 degrees, or greater than 120 degrees, and/or also provide an ultra-short total track length (TTL) 104, e.g., a TTL 104 less than 10 millimeters (mm), or less than 5 mm, or less than or equal to 4.2 mm. Parameters of lens 102 may also be selected to reduce, compensate, or correct for optical aberrations and lens artifacts and effects across the field of view including one or more of, but not limited to, defocus, spherical aberration, coma, astigmatism, distortion, the field curvature or Petzval sum, vignetting, chromatic aberration, lens flare, or the like. Parameters of lens 102 may also be selected to provide a high resolution image configured for high resolution image capture, e.g., with a modulation transfer function (MTF) compatible with an 8 megapixel (MP), 12 MP, 16 MP or greater camera. For example, sensor 108 may be an array of photosensitive pixels, and parameters of lens 102 may be selected to such that lens 102 has an MTF and image forming quality such that the pixel sizes of the sensor array 108 capturing the image limit the resolution of the captured image rather than the MTF and/or quality of lens 102.

Lens 102 may be configured to provide high quality (e.g., high resolution) image-forming with an ultra-wide field of view and a relatively short TTL 104 and with a relatively small object side lens surface. A relatively short TTL 104 and a relatively small object side lens surface may be advantageous for use with mobile devices. For example, a relatively short TTL 104 may enable a relatively thin mobile device. In some examples, lens 102 may have a relatively short TTL 104 such that a ratio of TTL 104 to a maximum image height is less than or equal to 2.000, or less than or equal to 1.800, or less than or equal to 1.627. Lens 102 may have a relatively small object side lens surface, which may reduce the surface area of a mobile device taken up by lens 102 and may reduce damage to the object side first surface, e.g., the smaller the object side surface, the less exposure of the surface to being damaged. In some examples, first lens element 110 may have a diameter that is less than or equal to 50% of TTL 104, or less than or equal to 42% of TTL 104, or less than or equal to 38% of TTL 104.

In some examples, lens elements 110-118 may be comprised of a plastic material, such as a polycarbonate, a polyester, a polystyrene, an acrylic such as poly(methyl methacrylate) (PMMA), or any suitable polymer, an injection molded plastic material, or other transparent materials (e.g., glass), and may include one or more coatings (e.g., anti-reflective coatings). In some examples, lens elements 110-118 may all comprise the same material, some of lens elements 110-118 may comprise the same material as each other, or each of lens elements 110-118 may comprise different materials from each other. For example, different lens elements of lens elements 110-118 may be comprised of materials with different optical characteristics, e.g., different indices of refraction (N_{d}) and different Abbe numbers (ν_{d}), where the Abbe number, ν_{d}, may be defined by equation (1):

$${ν}_{d} = ( {N}_{d} - 1 ) / ( {N}_{F} - {N}_{C} ) \qquad ( 1 )$$

where N_{F} and N_{C} are the refractive index values of the material at the F and C lines of hydrogen, respectively. In some examples, lens element 114 may be comprised of a plastic material having a relatively high refractive index, e.g., N_{d} greater than or equal to 1.68.

Sensor 108 may be an integrated circuit (IC) technology chip or chips implemented according to any of various types of photosensor technology. Examples of photosensor technology that may be used are charge-coupled device (CCD) technology and complementary metal-oxide-semiconductor (CMOS) technology. In some examples, sensor 108 may be a pixel array having a pixel size of 5 micrometers (microns) or less, or 2 microns or less, or 1 micron or less, although larger pixel sizes may be used. In some examples, the sensor 108 may have a 4032×3024 pixel image format, however, other pixel formats may be used. In some examples, sensor 108 may have a diagonal image height of about 5.040 mm, however, sensor 108 may have a larger or smaller diagonal size, e.g., with appropriate adjustments of lens 102, lens elements 110-118, and/or lens stop 122.

In some examples, lens 102 may include a cover glass (not shown). For example, a cover glass may be located on the object side of lens element 110 and may be configured to protect lens 102 from damage, e.g., environmental and/or contact with damaging materials. In some examples, the cover glass may be a hard glass, a glass and/or plastic with a hard coat, a sapphire, or any suitable material for protecting a surface of lens 102 (e.g., the object side surface of lens element 110). In some examples, the cover glass may have a small amount of optical power.

In the example shown, sensor 108 may be positioned at an image plane and/or focal plane of lens 102, and lens 102 is configured to form an image at sensor 108. The image size for a distant object is directly proportional to the effective focal length (EFL) of a lens 102. TTL 104 is the physical distance (also referred to as the mechanical distance, as opposed to an optical distance) along the optical axis (106) between the object side vertex 130 of lens element 110 and the image plane and/or focal plane.

In some examples, the lens 102 may have an EFL of less than or equal to 4 mm, or less than or equal to 3 mm, or less than or equal to 2.3 mm. Lens 102 may have an F-number (F/#) between about 1.0 and 5.0, or between about 1.5 and 3.0, or between about 2.0 and 2.4. Note that the F/#, also referred to as the focal ratio, may be defined by EFL/D, where D is the diameter of the entrance pupil, which is the image of lens stop 122 as seen from the object side of lens 102. In the example shown, lens 102 has an EFL of about 2.2 mm, an F/#of about 2.4, a DFOV of about 120 degrees, and a TTL 104 of about 3.9 mm.

In some examples, the EFL, F/#, TTL 104, sensor 108, and/or other lens system 100 and/or lens 102 parameters may vary, and may be scaled or adjusted to meet various specifications of optical, imaging, and/or packaging constraints. Constraints for a camera system that may be specified as requirements for lens system 100 and/or lens 102 and/or that may be varied for different camera system applications may include, but are not limited to, EFL, F/#, TTL 104, lens stop 122 location, DFOV, sensor 108 size, imaging performance requirements, and packaging volume or size constraints.

In some examples, the lens system 100 may be adjustable. For example, lens 102 may include an adjustable lens stop 122, e.g., via an iris configured to have an adjustable clear aperture size and/or diameter. Using an adjustable lens stop 122, the F/#may be dynamically varied within a range. In some examples, lens system 100 may be used at faster (e.g., lower) F/#by adjusting the aperture stop at the same DFOV, which my reduce or “trade off” imaging quality performance to increase the amount of light (brightness) captured by lens 102, which may allow the time of sensor 108 (e.g., and associated sensor noise), to be reduced, e.g., for low light conditions. In some examples, lens system 100 may be used at slower (e.g., higher) F/#by adjusting the aperture stop at the same DFOV, which may improve imaging quality performance and decrease the amount of light captured by lens 102, e.g., for brighter lighting conditions.

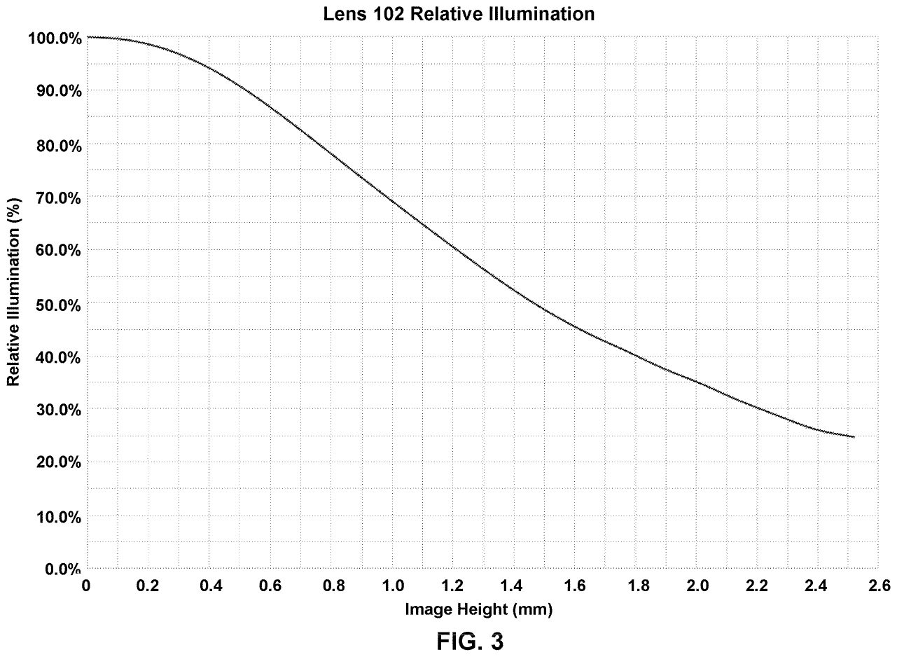

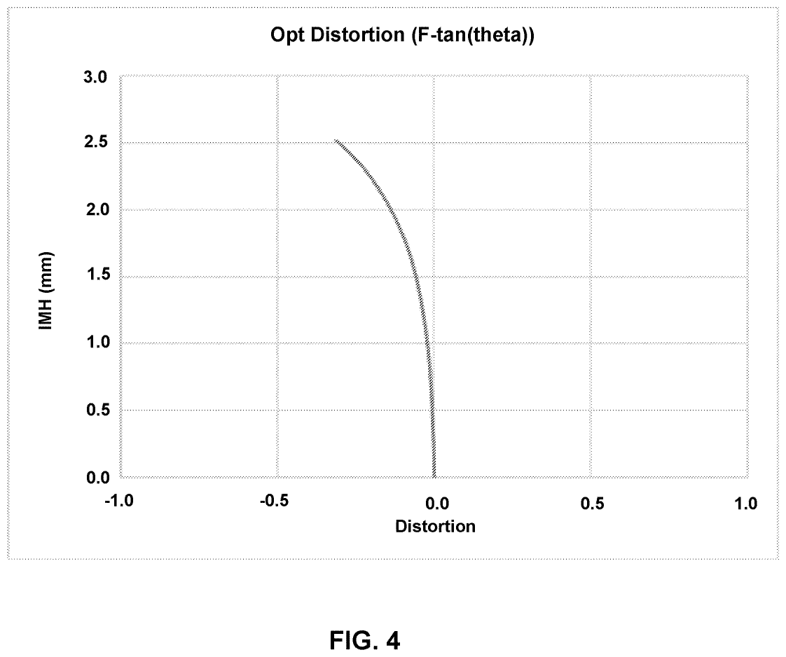

Tables 1 provides design details of lens system 100, Table 2 provides performance and/or quality details of lens system 100, and FIGS. 2-4 illustrate lens performance and/or quality of lens system 100. FIG. 2 is a plot of a modulation transfer function of the example lens system 100, FIG. 3 is a plot of a relative illumination of the example lens system 100, and FIG. 4 is a plot of a distortion of the example lens system 100. In FIG. 2 (as well as FIG. 4 below), the MTF at different fields, e.g., 40% of the DFOV, 70% of the DFOV, and 100% of the DFOV are plotted for both the tangential and sagittal planes. For example, the plot designated 0.4 S is the MTF of the sagittal plane at 40% DFOV, the plot designated 0.7 T is the MTF of the tangential plane at 70% DFOV, and “Diff Lim” is the MTF plot of the diffraction limit of the lens.

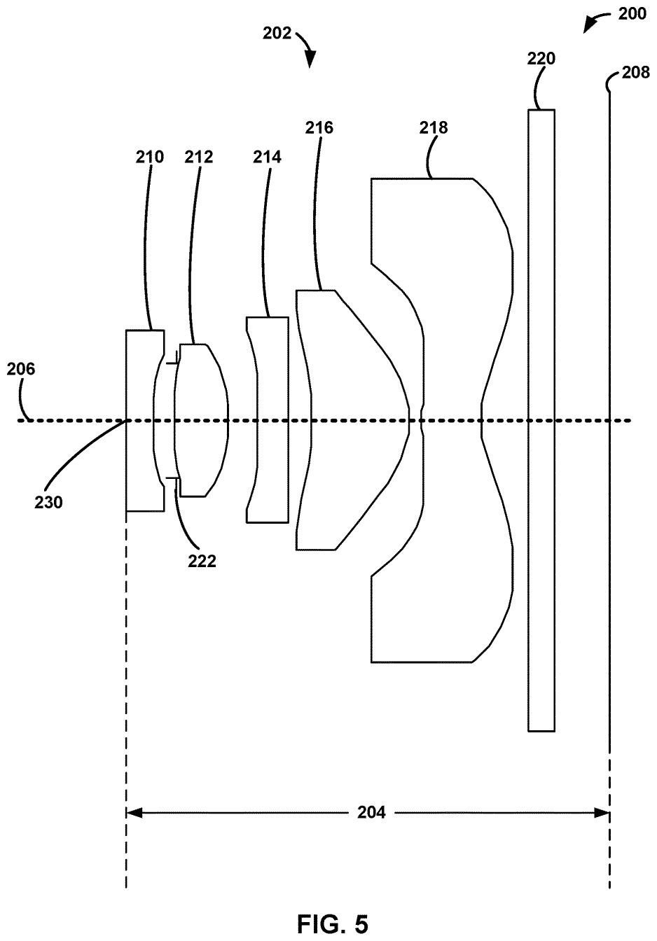

Tables 1 and 2 provide example values for various optical and physical parameters of lens systems 100 as described in reference to FIG. 1, and Tables 3 and 4 provide example values for various optical and physical parameters of lens systems 200 as described in reference to FIG. 5 below. In Tables 1-4, all dimensions are in millimeters (mm) unless otherwise specified. The surface numbers of the elements as shown in the Tables are listed from a first surface (surface 1) being the object side of the object side lens element, e.g., an object side of lens element 110 in Table 1 and an object side of lens element 210 in Table 3, to a last surface (surface 14) at the image plane/focal plane/photosensor surface. A positive radius indicates that the center of curvature is to the right (object side) of the surface. A negative radius indicates that the center of curvature is to the left (image side) of the surface. “Infinity” is as typically used in optics, e.g., indicating a planar surface having a “center of curvature” at “infinity”. The thickness (or separation) is the axial distance to the next surface. F/#stands for F-number of the lens system (e.g., F/2, F/2.4, F/4, or the like). HFOV stands for the horizontal field of view, VFOV stands for the vertical field of view, and DFOV stands for diagonal field of view. MKOC Position stands for the position of the intersection point of the maximum field of view and the central light, which may be a position of the entrance pupil of the maximum field of view. The EFL of Tables 1 and 3 indicate the effective focal length of the respective lens elements 110-118 or 210-218, respectively, and the EFL of Tables 2 and 4 indicated the overall effective focal length of lens 102 and lens 202, respectively. The optical total track of Tables 2 and 4 corresponds to TTL 104 and 204, respectively, and the mechanical total track may include a front portion of an example lens housing (not shown), e.g., which may extend away from the lens on the object side. For the materials of the lens elements and filter 120, refractive index N_{d} and the Abbe number are at the helium d-line wavelength.

Referring to the aspheric coefficients A2-A18 of Tables 1 and 3, the aspheric equation describing an aspherical surface may be given by equation (2):

$$Z = ( {cr}^{2} / ( 1 + sqrt [ 1 - ( 1 + K ) {c}^{2} {r}^{2} ] ) ) + {A}_{4} {r}^{4} + {A}_{6} {r}^{6} + {A}_{8} {r}^{8} + {A}_{10} {r}^{10} - {A}_{12} {r}^{12} - {A}_{14} {r}^{14} + {A}_{16} {r}^{16} + {A}_{18} {r}^{18} \qquad ( 2 )$$

where Z is the sag of surface parallel to the z-axis (the z-axis and the optical axis are coincident in these example embodiments), r is the radial distance from the vertex, c is the curvature at the pole or vertex of the surface (the reciprocal of the radius of curvature of the surface), K is the conic constant, and A4-A18 are the aspheric coefficients.

Note that the values given in the following Tables for the various parameters of example lens systems 100 and 200 are given by way of example and are not intended to be limiting. For example, one or more of the parameters for one or more of the surfaces of one or more of the lens elements, as well as parameters for the materials of which the elements are composed, may be given different values while still providing similar performance for the lens system. In particular, note that some values in the Tables may be scaled up or down for larger or smaller implementations of a camera using examples lens system 100 and/or 200.

TABLE 1

| | | | | CA | | | | |
|---|---|---|---|---|---|---|---|---|
| | Element | | Radius | Diameter | Thickness | | | |
| Element | EFL (mm) | Surface | (mm) | (mm) | (mm) | Nd | Abbe # | Conic |
| 110 | −4.156(S1~S2) | 1 | −5.446 | 1.446 | 0.210 | 1.545 | 55.987 | 0.019 |
| | | 2 | 3.947 | 1.042 | 0.186 | | | 12.550 |
| 122 | | 3 | Infinity | 0.930 | −0.018 | | | 0.000 |
| 112 | 1.801(S3~S4) | 4 | 2.448 | 1.002 | 0.439 | 1.545 | 55.987 | −6.178 |
| | | 5 | −1.540 | 1.204 | 0.229 | | | 2.537 |
| 114 | −20.828(S6~S7) | 6 | 12.046 | 1.440 | 0.256 | 1.681 | 18.436 | −9.063 |
| | | 7 | 6.487 | 1.662 | 0.189 | | | 20.994 |
| 116 | 1.493(S8~S9) | 8 | −1.959 | 1.798 | 0.781 | 1.545 | 55.987 | −3.535 |
| | | 9 | −0.657 | 2.080 | 0.105 | | | −2.868 |
| 118 | −1.505(S10~S11) | 10 | 3.330 | 2.520 | 0.472 | 1.639 | 23.487 | 2.203 |
| | | 11 | 0.709 | 3.880 | 0.384 | | | −4.684 |
| 120 | | 12 | Infinity | 5.000 | 0.210 | N-BK7 | | 0.000 |
| | | 13 | Infinity | 5.000 | 0.443 | | | 0.000 |
| 108 | | 14 | Infinity | 5.283 | | | | |

| Surface | A4 | A6 | A8 | A10 | A12 | A14 | A16 | A18 |
|---|---|---|---|---|---|---|---|---|
| 1 | 0.000 | 0.338 | −0.457 | 0.045 | 0.588 | −0.620 | 0.000 | 0.000 |
| 2 | 0.000 | 0.707 | −1.215 | 8.189 | −35.218 | 80.415 | −38.646 | 0.000 |
| 3 | 0.000 | 0.000 | 0.000 | 0.000 | 0.000 | 0.000 | 0.000 | 0.000 |
| 4 | 0.000 | 0.091 | −0.392 | −0.199 | 0.000 | 0.000 | 0.000 | 0.000 |
| 5 | 0.000 | −0.300 | 0.402 | −2.002 | 4.618 | −5.865 | 0.000 | 0.000 |
| 6 | 0.000 | −0.506 | 0.067 | 0.499 | −0.833 | 1.101 | 0.000 | 0.000 |
| 7 | 0.000 | −0.202 | −0.580 | 3.216 | −7.548 | 11.242 | −9.873 | 3.788 |
| 8 | 0.000 | 0.172 | −0.839 | 2.311 | −2.727 | 1.676 | −0.502 | 0.000 |
| 9 | 0.000 | −0.249 | 0.175 | −0.915 | 2.889 | −4.287 | 3.138 | −0.872 |
| 10 | 0.000 | −0.286 | −0.261 | 0.674 | −0.681 | 0.334 | −0.084 | 0.012 |
| 11 | 0.000 | −0.199 | 0.135 | −0.064 | 0.018 | −0.003 | 0.000 | 0.000 |

TABLE 2

| Sensor 108 | | | Units |
|---|---|---|---|
| Format | Horizontal | 4032 | pixels |
| | Vertical | 3024 | pixels |
| | Pitch Size | 1 | um |
| Nyquist | | 500 | lp/mm |
| Frequency | | | |
| Filter 120 | IRF | 0.21 | mm |
| | IRF_Nd | 1.516 | |
| | IRF_Vd | 64.16 | |

| Parameter/Metric | | Lens 102 | Unit |
|---|---|---|---|
| Paraxial | EFL | 2.10 | mm |
| Focal Length | | | |
| F Number | F# | 2.4 | |
| Field | HFOV | 96.2 | deg |
| of View | VFOV | 74.8 | deg |
| | DFOV | 120.2 | deg |
| MTF F/4 | Center | 77.22 | % |
| 125 lp/mm | 0.4F | T 58.8/S 74.2 | % |
| | 0.8F | T 47.2/S 64.1 | % |
| MTF F/2 | Center | 55.5 | % |
| 250 lp/mm | 0.4F | T 30.8/S 50.1 | % |
| | 0.8F | T 13/S 38.6 | % |
| Astigmatism | | 0.007 | mm |
| Lateral Color | All field | 6.0 | um |
| Aberration- | | | |
| All field | | | |
| Mechanical | MBFL | 0.65 | mm |
| Back Focal | | | |
| Length | | | |
| Optical | TTL | 3.9 | mm |
| Total Track | | | |
| Optical | FB | 0.65 | mm |
| Flange Back | | | |
| Length | | | |
| MKOC Position | | 0.50 | |
| Distortion | DIST | −31.2 | % |
| | TV_DIST | −7.8 | % |
| Chief | CRA | 39.2 | deg |
| Ray Angle | | | |
| Maximum | MIC | 5.24 | mm |
| Image Circle | | | |
| Relative | RI | 24.70 | % |
| Illumination | | | |

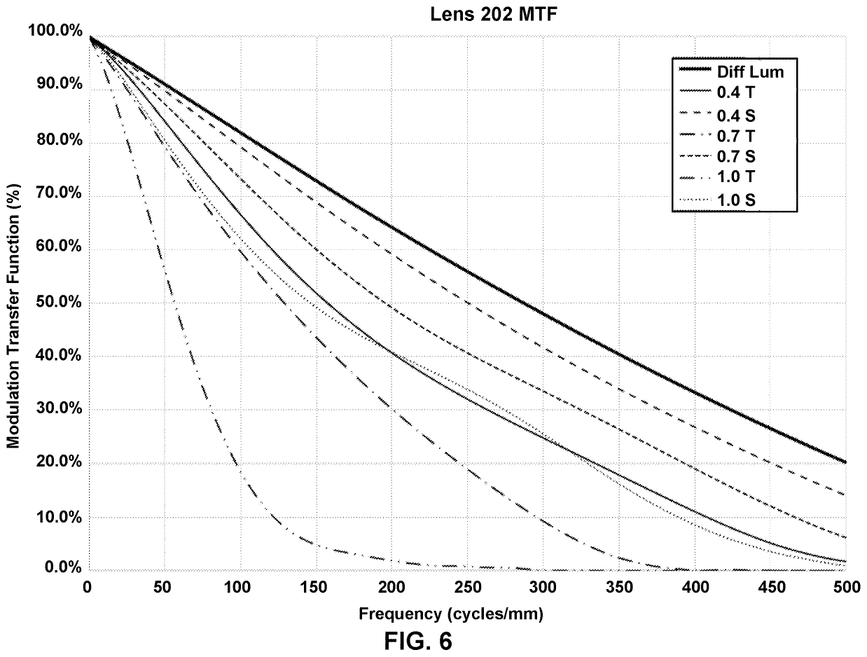

FIG. 5 is a cross-sectional diagram of an example lens system 200, in accordance with one or more aspects of the present disclosure. Lens system 200 of FIG. 5 may be substantially similar to lens system 100 of FIG. 1, but has different lens parameters, e.g., lens 202 has different lens design parameters from lens 102. FIGS. 6-8 are plots illustrating lens performance and/or quality of lens system 200. Lens system 200 may include lens 202 and sensor 108, and lens 202 may include a plurality of lens elements, e.g., two or more lens elements.

In the example shown, lens 202 may include five lens elements 210, 212, 214, 216, and 218 arranged in order along an optical axis 106 from an object side to an image side, e.g., with lens element 210 as the object side lens element and lens element 218 as the image side lens element. Lens 202 also may include lens stop 222 arranged on an object side of lens element 212, e.g., between lens elements 210 and 212. In other examples, lens stop 222 may be located anywhere within lens 202, e.g., anywhere within TTL 204. In some examples, lens stop 222 may be a mechanical aperture comprising an opaque material and configured to have a clear aperture, and in other examples lens stop 222 may be one of lens elements 210-218. In some examples, lens 202 may include filter 120. Filter 120 may be a separate component as described above, or in some examples, filter 120 may comprise a coating on a surface of one or more of lens elements 210-218 and/or a surface of sensor 108, or other methods or components may be used to provide optical filtering.

Parameters of lens 202, e.g., the overall lens 202 optical power, the optical powers of lens elements 210-218, the lens shapes, thicknesses, geometries, positions, materials, spacings, and the surface shapes of lens elements 210-218 may be selected, at least in part, to provide an ultra-wide field of view, e.g., a diagonal field of view (DFOV) greater than 90 degrees, or greater than 105 degrees, or greater than 120 degrees, and/or also provide an ultra-short total track length (TTL) 204, e.g., a TTL 204 less than 10 millimeters (mm), or less than 5 mm, or less than or equal to 4.2 mm. Parameters of lens 202 may also be selected to reduce, compensate, or correct for optical aberrations and lens artifacts and effects across the field of view including one or more of, but not limited to, defocus, spherical aberration, coma, astigmatism, distortion, the field curvature or Petzval sum, vignetting, chromatic aberration, lens flare, or the like. Parameters of lens 202 may also be selected to provide a high-resolution image configured for high resolution image capture, e.g., with a modulation transfer function (MTF) compatible with an 8 megapixel (MP), 12 MP, 16 MP or greater camera. For example, sensor 108 may be an array of photosensitive pixels, and parameters of lens 202 may be selected to such that lens 202 has an MTF and image forming quality such that the pixel sizes of the sensor array 108 capturing the image limit the resolution of the captured image rather than the MTF and/or quality of lens 202.

Lens 202 may be configured to provide high quality (e.g., high resolution) image-forming with an ultra-wide field of view and a relatively short TTL 204 and with a relatively small object side lens surface. A relatively short TTL 204 and a relatively small object side lens surface may be advantageous for use with mobile devices. For example, a relatively short TTL 204 may enable a relatively thin mobile device. In some examples, lens 202 may have a relatively short TTL 204 such that a ratio of TTL 204 to a maximum image height is less than or equal to 2.000, or less than or equal to 1.800, or less than or equal to 1.627. Lens 202 may have a relatively small object side lens surface, which may reduce the surface area of a mobile device taken up by lens 202 and may reduce damage to the object side first surface, e.g., the smaller the object side surface, the less exposure of the surface to being damaged. In some examples, first lens element 210 may have a diameter that is less than or equal to 50% of TTL 204, or less than or equal to 42% of TTL 204, or less than or equal to 38% of TTL 204.

In some examples, lens elements 210-218 may be comprised of a plastic material, an injection molded plastic material, or other transparent materials (e.g., glass), and may include one or more coatings (e.g., anti-reflective coatings). In some examples, lens elements 210-218 may all be formed of the same material, some of lens elements 210-218 may be formed of the same material as each other, or each of lens elements 210-218 may be formed of different materials from each other. For example, different lens elements of lens elements 210-218 may be formed of materials with different optical characteristics, e.g., different indices of refraction (N_{d}) and different Abbe numbers (ν_{d}), (e.g., defined by equation (1) above). In some examples, lens element 214 may be comprised of a plastic material having a relatively high refractive index, e.g., Nd greater than or equal to 1.68.

In some examples, lens 202 may include a cover glass (not shown). For example, a cover glass may be located on the object side of lens element 210 and may be configured to protect lens 202 from damage, e.g., environmental and/or contact with damaging materials. In some examples, the cover glass may be a hard glass, a glass and/or plastic with a hard coat, a sapphire, or any suitable material for protecting a surface of lens 202 (e.g., the object side surface of lens element 210). In some examples, the cover glass may have a small amount of optical power.

In the example shown, sensor 108 may be positioned at an image plane and/or focal plane of lens 202, and lens 202 is configured to form an image at sensor 108. The image size for a distant object is directly proportional to the effective focal length (EFL) of a lens 202. TTL 204 is the physical distance (also referred to as the mechanical distance, as opposed to an optical distance) along the optical axis (106) between the object side vertex 230 of lens element 210 and the image plane and/or focal plane.

In some examples, the lens 202 may have an EFL of less than or equal to 4 mm, or less than or equal to 3 mm, or less than or equal to 2.3 mm. Lens 202 may have an F-number (F/#) between about 1.0 and 5.0, or between about 1.5 and 3.0, or between about 2.0 and 2.4. Note that the F/#, also referred to as the focal ratio, is defined by EFL/D, where D is the diameter of the entrance pupil, which is the image of lens stop 222 as seen from the object side of lens 202. In the example shown, lens 202 has an EFL of about 2.1 mm, an F/#of about 2.4, a DFOV of about 120 degrees, and a TTL 204 of about 4.05 mm.

In some examples, the EFL, F/#, TTL 204, sensor 108, and/or other lens system 200 and/or lens 202 parameters may vary, and may be scaled or adjusted to meet various specifications of optical, imaging, and/or packaging constraints. Constraints for a camera system that may be specified as requirements for lens system 200 and/or lens 202 and/or that may be varied for different camera system applications may include, but are not limited to, EFL, F/#, TTL 204, lens stop 222 location, DFOV, sensor 108 size, imaging performance requirements, and packaging volume or size constraints.

In some examples, the lens system 200 may be adjustable. For example, lens 202 may include an adjustable lens stop 222, e.g., via an iris configured to have an adjustable clear aperture size and/or diameter. Using an adjustable lens stop 222, the F/#may be dynamically varied within a range. In some examples, lens system 200 may be used at faster (e.g., lower) F/#by adjusting the aperture stop at the same DFOV, which my reduce or “trade off” imaging quality performance to increase the amount of light (brightness) captured by lens 202, which may allow the time of sensor 108 (e.g., and associated sensor noise), to be reduced, e.g., for low light conditions. In some examples, lens system 200 may be used at slower (e.g., higher) F/#by adjusting the aperture stop at the same DFOV, which may improve imaging quality performance and decrease the amount of light captured by lens 202, e.g., for brighter lighting conditions.

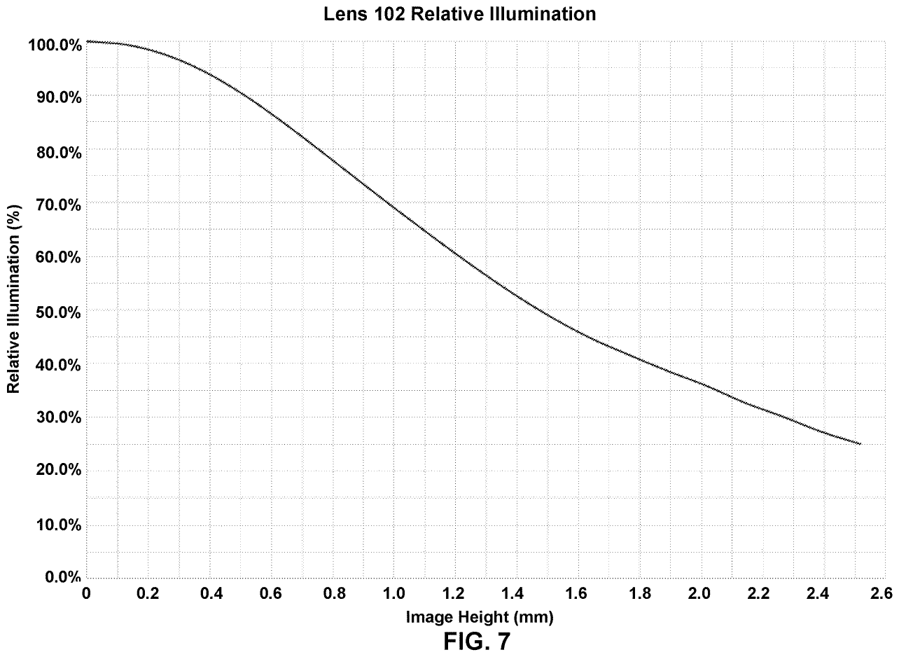

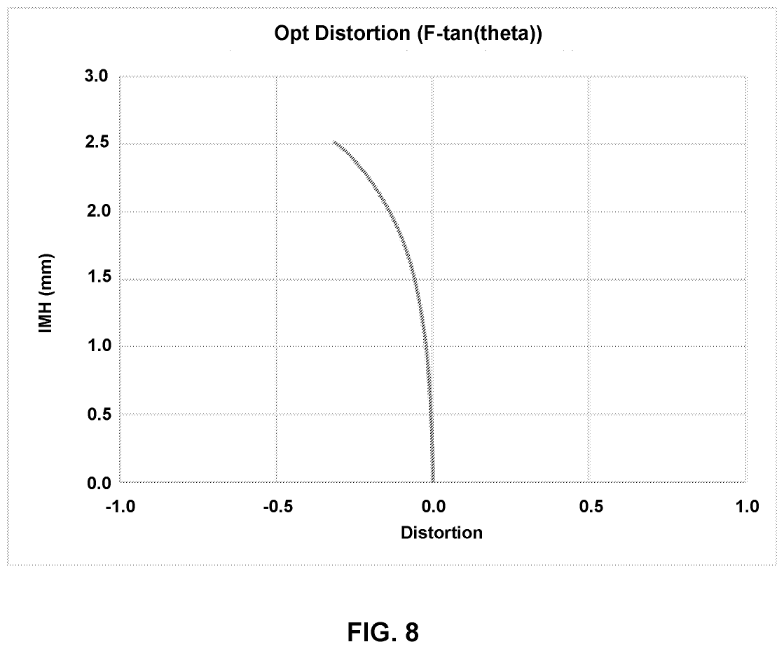

Table 3 provides design details of lens system 200, Table 4 provides performance and/or quality details of lens system 200, and FIGS. 6-8 illustrate lens performance and/or quality of lens system 200. FIG. 6 is a plot of a modulation transfer function of the example lens system 200, FIG. 7 is a plot of a relative illumination of the example lens system 200, and FIG. 8 is a plot of a distortion of the example lens system 200.

TABLE 3

| | Element | | | CA | | | | |
|---|---|---|---|---|---|---|---|---|
| | EFL | | Radius | Diameter | Thickness | | Abbe | |
| Element | (mm) | Surface | (mm) | (mm) | (mm) | Nd | # | Conic |
| 210 | −4.156 | 1 | −8.675 | 1.498 | 0.210 | 1.545 | 55.987 | −7.195 |
| | | 2 | 3.290 | 1.498 | 0.224 | | | 2.053 |
| 222 | | 3 | Infinity | 0.934 | −0.017 | | | 0.000 |
| 212 | 1.801 | 4 | 2.376 | 1.236 | 0.489 | 1.545 | 55.987 | −3.103 |
| | | 5 | −1.683 | 1.236 | 0.214 | | | 2.235 |
| 214 | −20.828 | 6 | 12.984 | 1.678 | 0.251 | 1.681 | 18.436 | 0.000 |
| | | 7 | 7.104 | 1.678 | 0.182 | | | 0.000 |
| 216 | 1.493 | 8 | −2.207 | 2.140 | 0.839 | 1.545 | 55.987 | −3.003 |
| | | 9 | −0.684 | 2.140 | 0.080 | | | −2.751 |
| 218 | −1.505 | 10 | 3.601 | 4.000 | 0.530 | 1.639 | 23.487 | 2.499 |
| | | 11 | 0.738 | 4.000 | 0.385 | | | −4.558 |
| 120 | | 12 | Infinity | 5.000 | 0.210 | N-BK7 | | 0.000 |
| | | 13 | Infinity | 5.000 | 0.448 | | | 0.000 |
| 108 | | 14 | Infinity | 5.283 | | | | |

| Surface | A4 | A6 | A8 | A10 | A12 | A14 | A16 |
|---|---|---|---|---|---|---|---|
| 1 | 0.335 | −0.566 | 0.895 | −1.731 | 2.332 | −1.353 | 0.000 |
| 2 | 0.672 | −1.151 | 6.081 | −18.798 | 30.128 | 0.000 | 0.000 |
| 3 | 0.000 | 0.000 | 0.000 | 0.000 | 0.000 | 0.000 | 0.000 |
| 4 | 0.075 | −0.263 | 0.078 | 0.372 | 0.000 | 0.000 | 0.000 |
| 5 | −0.284 | 0.309 | −0.907 | 1.241 | 0.000 | 0.000 | 0.000 |
| 6 | −0.544 | 0.542 | −1.683 | 3.398 | −2.116 | 0.353 | 0.000 |
| 7 | −0.280 | 0.286 | −0.189 | 0.172 | −0.061 | 0.000 | 0.000 |
| 8 | 0.085 | −0.261 | 1.022 | −1.282 | 0.095 | 1.049 | −0.650 |
| 9 | −0.216 | −0.003 | 0.003 | 0.437 | −0.816 | 0.594 | −0.142 |
| 10 | −0.268 | −0.213 | 0.603 | −0.713 | 0.463 | −0.174 | 0.031 |
| 11 | −0.175 | 0.116 | −0.057 | 0.018 | −0.004 | 0.000 | 0.000 |

TABLE 4

| Sensor 108 | | | Units |
|---|---|---|---|
| Format | Horizontal | 4032 | pixels |
| | Vertical | 3024 | pixels |
| | Pitch Size | 1 | um |
| Nyquist | | 500 | lp/mm |
| Frequency | | | |
| Filter 120 | IRF | 0.21 | mm |
| | IRF_Nd | 1.516 | |
| | IRF_Vd | 64.16 | |

| Parameter/Metric | | Lens 102 | Unit |
|---|---|---|---|
| Paraxial | EFL | 2.10 | mm |
| Focal Length | | | |
| F Number | F# | 2.4 | |
| Field | HFOV | 96.2 | deg |
| of View | VFOV | 74.8 | deg |
| | DFOV | 120.2 | deg |
| MTF F/4 | Center | 77.22 | % |
| 125 lp/mm | 0.4F | T 58.8/S 74.2 | % |
| | 0.8F | T 47.2/S 64.1 | % |
| MTF F/2 | Center | 55.5 | % |
| 250 lp/mm | 0.4F | T 30.8/S 50.1 | % |
| | 0.8F | T 13/S 38.6 | % |
| Astigmatism | | 0.007 | mm |
| Lateral Color | All field | 6.0 | um |
| Aberration- | | | |
| All field | | | |
| Mechanical | MBFL | 0.65 | mm |
| Back Focal | | | |
| Length | | | |
| Optical | TTL | 3.9 | mm |
| Total Track | | | |
| Optical | FB | 0.65 | mm |
| Flange Back | | | |
| Length | | | |
| MKOC Position | | 0.50 | |
| Distortion | DIST | −31.2 | % |
| | TV_DIST | −7.8 | % |
| Chief | CRA | 39.2 | deg |
| Ray Angle | | | |
| Maximum | MIC | 5.24 | mm |
| Image Circle | | | |
| Relative | RI | 24.70 | % |
| Illumination | | | |

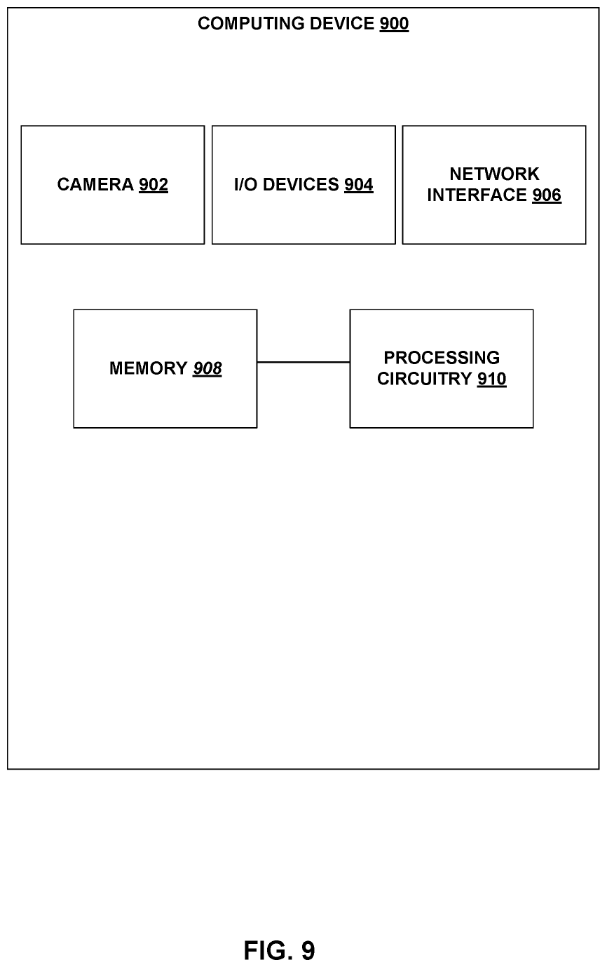

FIG. 9 is an example computing system 900 that may be used with a camera 902 including example lens system 100 and/or example lens system 200, in accordance with one or more aspects of the present disclosure. Computing system 900 may implement methods for controlling operations of camera 902 using lens system 100 or lens system 200, and/or for performing image processing of images captured with the camera 902.

In some examples, computing system 900 may be any of various types of devices, including, but not limited to, a personal computer system, desktop computer, laptop, notebook, tablet or pad device, slate, or netbook computer, mainframe computer system, handheld computer, workstation, network computer, a camera, a set top box, a mobile device, a wireless phone, a smartphone, a consumer device, video game console, handheld video game device, application server, storage device, a television, a video recording device, a peripheral device such as a switch, modem, router, or in general any type of computing or electronic device.

In the example shown, computing system 900 may include processing circuitry 910 (e.g., one or more processors) coupled to a memory 908. computing system 900 also may include a network interface 906, input/output devices 904, e.g., a cursor control device, mouse, touchpad, trackball, a keyboard, a display, or the like. Computing system 900 also may include one or more cameras 902 which may include a lens system, e.g., lens system 100 and/or 200.

Memory 908 may be configured to store program instructions and/or data accessible by processing circuitry 910. Memory 908 may be implemented using any suitable memory technology, such as static random access memory (SRAM), synchronous dynamic RAM (SDRAM), nonvolatile/Flash-type memory, or any other type of memory. Program instructions may be configured to implement various interfaces, methods and/or data for controlling operations of camera 902 and for capturing and processing images with camera 902 or other methods or data, for example interfaces and methods for capturing, displaying, processing, and storing images captured with camera 902. In some examples, program instructions and/or data may be received, sent or stored upon different types of computer-accessible media or on similar media separate from system memory 908 or computing system 900.

Network interface 906 may be configured to allow data to be exchanged between computing system 900 and other devices attached to a network (e.g., carrier or agent devices) or between nodes of computing system 900. Network interface 906 may include one or more networks including but not limited to Local Area Networks (LANs) (e.g., an Ethernet or corporate network), Wide Area Networks (WANs) (e.g., the Internet), wireless data networks, some other electronic data network, or some combination thereof. Network interface 906 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 904 may include one or more display terminals, keyboards, keypads, touchpads, scanning devices, voice or optical recognition devices, or any other devices suitable for entering or accessing data by computing system 900. Multiple input/output devices 904 may be present in computing system 900 or may be distributed on various nodes of computing system 900. In some examples, similar input/output devices 904 may be separate from computing system 900 and may interact with one or more nodes of computing system 900 through a wired or wireless connection, such as over network interface 906.

In the example shown, memory 908 may include program instructions which may be processor-executable to implement any element or action to support camera 902, including but not limited to image processing software and interface software for controlling camera 902. In some examples, images captured by camera 902 may be stored to memory 908. In addition, metadata for images captured by camera 902 may be stored using memory 908.

Computing system 900 and devices described herein may include any combination of hardware or software that can perform the indicated functions, including computers, network devices, Internet appliances, PDAs, wireless phones, pagers, video or still cameras, and the like. Computing system 900 may also be connected to other devices that are not illustrated, or instead may operate as a stand-alone system. In addition, the functionality provided by the illustrated components may, in some examples, be combined in fewer components or distributed in additional components. Similarly, in some examples, the functionality of some of the illustrated components may not be provided and/or other additional functionality may be available.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, may include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

This disclosure includes the following examples:
Example 1. A lens comprising: a plurality of optical elements arranged along an optical axis, wherein the plurality of optical elements comprises, in order from an object side to an image side of the lens: a first refractive lens element; an aperture stop; a second refractive lens element; a third refractive lens element; a fourth refractive lens element; and a fifth refractive lens element, and wherein a diameter of the first refractive lens element is less than 50% of a total track length of the of lens.
Example 2. The lens of example 1, wherein a diagonal field of view of the lens is greater than or equal to 120 degrees.
Example 3. The lens of example 1 or example 2, wherein a ratio of the total track length to maximum image height is less than or equal to 1.627.
Example 4. The lens of example 3, wherein the image height is a height in an image plane relative to the optical axis of the lens at which a relative illumination is 25%.
Example 5. The lens of any one of examples 1 through 4, wherein the third refractive lens element comprises an index of refraction (Nd) greater than 1.68, wherein the first refractive lens element, the second refractive lens element, the third refractive lens element, the fourth refractive lens element, and the fifth refractive lens element each comprise a plastic.
Example 6. The lens of example 5, wherein at least one of the first, second, fourth, or fifth refractive lens elements comprises an index of refraction (Nd) greater than 1.68.
Example 7. The lens of example 5, wherein each of the first, second, fourth, or fifth refractive lens elements comprises an index of refraction (Nd) less than or equal to 1.68.
Example 8. The lens of any one of examples 1 through 7, wherein an effective focal length of the lens is less than or equal to 2.3 millimeter (mm).
Example 9. The lens of any one of examples 1 through 8, wherein the total track length of the lens is less than or equal to 4.2 mm.
Example 10. The lens of any one of examples 1 through 9, wherein an effective focal length of the first refractive lens element is between negative 4.35 mm and negative 4.10 mm, wherein an effective focal length of the second refractive lens element is between 1.80 mm and 1.90 mm, wherein an effective focal length of the third refractive lens element is between negative 24.00 mm and negative 20.00 mm, wherein an effective focal length of the fourth refractive lens element is between 1.45 mm and 1.55 mm, wherein an effective focal length of the fifth refractive lens element is between negative 1.60 mm and negative 1.50 mm.
Example 11. A camera comprising: the lens of claim 1; and a sensor disposed at an image plane of the lens.
Example 12. The camera of example 11, further comprising an infrared cut filter disposed between the sensor and the fifth refractive lens element.
Example 13. The camera of example 11 or example 12, wherein a diagonal field of view of the lens is greater than or equal to 120 degrees, and wherein a ratio of the total track length to maximum image height is less than or equal to 1.627.
Example 14. The camera of example 13, wherein the image height is a height in the image plane relative to the optical axis of the lens at which a relative illumination is 25%, and wherein the third refractive lens element comprises an index of refraction (Nd) greater than 1.68.
Example 15. The camera of example 14, wherein at least one of the first, second, fourth, or fifth refractive lens elements comprises an index of refraction (Nd) greater than 1.68.
Example 16. The camera of example 14, wherein each of the first, second, fourth, or fifth refractive lens elements comprises an index of refraction (Nd) less than or equal to 1.68.
Example 17. The camera of any one of examples 11 through 16, wherein an effective focal length of the lens is less than or equal to 2.3 millimeter (mm).
Example 18. The camera of any one of examples 11 through 17, wherein the total track length of the lens is less than or equal to 4.2 mm.
Example 19. The camera of any one of examples 11 through 18, wherein an effective focal length of the first refractive lens element is between negative 4.35 mm and negative 4.10 mm, wherein an effective focal length of the second refractive lens element is between 1.80 mm and 1.90 mm, wherein an effective focal length of the third refractive lens element is between negative 2.40 mm and negative 2.00 mm, wherein an effective focal length of the fourth refractive lens element is between 1.45 mm and 1.55 mm, wherein an effective focal length of the fifth refractive lens element is between negative 1.60 mm and negative 1.50 mm.
Example 20. A device comprising: a processor; a camera; and a memory comprising instructions executable by the processor to control operations of the cameras, wherein the camera comprises: a lens comprising: a plurality of optical elements arranged along an optical axis, wherein the plurality of optical elements comprises, in order from an object side to an image side of the lens: a first refractive lens element; an aperture stop; a second refractive lens element; a third refractive lens element; a fourth refractive lens element; and a fifth refractive lens element, and wherein a diameter of the first refractive lens element is less than 50% of a total track length of the of lens; a sensor disposed at an image plane of the lens; and an infrared cut filter disposed between the sensor and the fifth refractive lens element.
Example 21. The device of claim 20, wherein the first refractive lens element, the second refractive lens element, the third refractive lens element, the fourth refractive lens element, and the fifth refractive lens element each comprise a plastic.

Various examples of the disclosure have been described. Any combination of the described systems, operations, or functions is contemplated. These and other examples are within the scope of the following claims.

1. A lens comprising:
a plurality of optical elements arranged along an optical axis, wherein the plurality of optical elements comprises, in order from an object side to an image side of the lens:
a first refractive lens element;
an aperture stop;
a second refractive lens element;
a third refractive lens element;
a fourth refractive lens element; and
a fifth refractive lens element, and
wherein a diameter of the first refractive lens element is less than 50% of a total track length of the of lens.

2. The lens of claim 1, wherein a diagonal field of view of the lens is greater than or equal to 120 degrees.

3. The lens of claim 1 or claim 2, wherein a ratio of the total track length to maximum image height is less than or equal to 1.627.

4. The lens of claim 3, wherein the image height is a height in an image plane relative to the optical axis of the lens at which a relative illumination is 25%.

5. The lens of any one of claims 1 through 4, wherein the first refractive lens element, the second refractive lens element, the third refractive lens element, the fourth refractive lens element, and the fifth refractive lens element each comprise a plastic, and
wherein the third refractive lens element comprises an index of refraction (Nd) greater than 1.68.

6. The lens of claim 5, wherein at least one of the first, second, fourth, or fifth refractive lens elements comprises an index of refraction (Nd) greater than 1.68.

7. The lens of claim 5, wherein each of the first, second, fourth, or fifth refractive lens elements comprises an index of refraction (Nd) less than or equal to 1.68.

8. The lens of any one of claims 1 through 7, wherein an effective focal length of the lens is less than or equal to 2.3 millimeter (mm).

9. The lens of any one of claims 1 through 8, wherein the total track length of the lens is less than or equal to 4.2 mm.

10. The lens of any one of claims 1 through 9, wherein an effective focal length of the first refractive lens element is between negative 4.35 mm and negative 4.10 mm, wherein an effective focal length of the second refractive lens element is between 1.80 mm and 1.90 mm, wherein an effective focal length of the third refractive lens element is between negative 24.00 mm and negative 20.00 mm, wherein an effective focal length of the fourth refractive lens element is between 1.45 mm and 1.55 mm, wherein an effective focal length of the fifth refractive lens element is between negative 1.60 mm and negative 1.50 mm.

11. A camera comprising:
the lens of claim 1; and
a sensor disposed at an image plane of the lens.

12. The camera of claim 11, further comprising an infrared cut filter disposed between the sensor and the fifth refractive lens element.

13. The camera of claim 11 or claim 12, wherein a diagonal field of view of the lens is greater than or equal to 120 degrees, and wherein a ratio of the total track length to maximum image height is less than or equal to 1.627.

14. The camera of claim 13, wherein the image height is a height in the image plane relative to the optical axis of the lens at which a relative illumination is 25%, and wherein the third refractive lens element comprises an index of refraction (Nd) greater than 1.68.

15. The camera of claim 14, wherein at least one of the first, second, fourth, or fifth refractive lens elements comprises an index of refraction (Nd) greater than 1.68.

16. The camera of claim 14, wherein each of the first, second, fourth, or fifth refractive lens elements comprises an index of refraction (Nd) less than or equal to 1.68.

17. The camera of any one of claims 11 through 16, wherein an effective focal length of the lens is less than or equal to 2.3 millimeter (mm).

18. The camera of any one of claims 11 through 17, wherein the total track length of the lens is less than or equal to 4.2 mm.

19. The camera of any one of claims 11 through 18, wherein an effective focal length of the first refractive lens element is between negative 4.35 mm and negative 4.10 mm, wherein an effective focal length of the second refractive lens element is between 1.80 mm and 1.90 mm, wherein an effective focal length of the third refractive lens element is between negative 2.40 mm and negative 2.00 mm, wherein an effective focal length of the fourth refractive lens element is between 1.45 mm and 1.55 mm, wherein an effective focal length of the fifth refractive lens element is between negative 1.60 mm and negative 1.50 mm.

20. A device comprising:
a processor;
a camera; and
a memory comprising instructions executable by the processor to control operations of the cameras,
wherein the camera comprises:
a lens comprising:
a plurality of optical elements arranged along an optical axis, wherein the plurality of optical elements comprises, in order from an object side to an image side of the lens:
a first refractive lens element;
an aperture stop;
a second refractive lens element;
a third refractive lens element;
a fourth refractive lens element; and
a fifth refractive lens element, and
wherein a diameter of the first refractive lens element is less than 50% of a total track length of the of lens;
a sensor disposed at an image plane of the lens; and
an infrared cut filter disposed between the sensor and the fifth refractive lens element.
